(19) United States
(12) Patent Application Publication
(10) Pub. No.: US 2010/0019040 A1
(43) Pub. Date: Jan. 28, 2010

(54) PORTABLE SCANNER DEVICE WITH INTEGRAL AUDIO OUTPUT

(76) Inventors: Marlene Haber, Atlanta, GA (US); Mark Haber, Atlanta, GA (US)

Correspondence Address: GEORGE R. REARDON, 3356 STATION COURT, LAWRENCVILLE, GA, 30044, US

(21) Appl. No.: 12/049,270

(22) Filed: Mar. 15, 2008

(51) Int. Cl. G06K 7/00; G06K 7/10

(52) U.S. Cl. 235/440; 235/462.01

(57) ABSTRACT

A portable scanner device with integral audio output for audibly identifying a multiplicity of scanned items for a user is disclosed. The portable scanner device comprises a hand-held housing, a sensor disposed within the housing (the sensor configured to detect and sense a scanned item), an audio output to aurally present audio data to the user of the portable scanner device, a processor to identify the scanned item and to generate an audio response through the audio output, a memory configured to store a plurality of data items for the processor, and a power source disposed within the housing. A speaker, an earphone, a headset and/or a wireless ear piece are used to present the audio data to the user of the portable scanner device.

### FIELD OF THE INVENTION

The technology described herein relates generally to scanning devices. More specifically, the technology described herein relates to a scanning device and method that provides audio output of items or locations scanned and/or detected.

### BACKGROUND OF THE INVENTION

There are situations where people need audio assistance in their own language in identifying items and information associated with these items. These situations include a person not understanding the language associated with the item, a person who is illiterate, a person who is visually impaired, and/or a person on a restricted diet, e.g. a diabetic or a person on a low-sodium or low-fat diet. The item to be identified audibly includes retail items, isles within a retail establishment, name of a location, an airport gate, and the like.

As an example, the above mentioned people may desire detailed product information, e.g. brand, size, price and ingredients, which are not readily available without the assistance of another person to actually read the information for the container label of a product.

Consequently, there is a need for a device and related method for assisting persons in obtaining product and other information during shopping or during other activities.

These and other problems exist. Previous attempts to solve these and other problems include the following.

U.S. Pat. No. 5,917,174, issued to Moore et al. Jun. 29, 1999, discloses a device for assisting the visually impaired in product recognition and related methods.

U.S. Published Patent Application 2002/0121986, inventors Krukowski et al., published on Sep. 5, 2002, discloses a method and system for identifying an object and announcing a voice message.

The foregoing patent and other information reflect the state of the art of which the inventor is aware and are tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In general, the technology described herein is directed to a method and a portable device for assisting a user to identify items and/or locations, e.g. retail items in a store, gates at an airport.

The device uses either a bar code and/or an RFID to generate an audio response, e.g. “Acme green peas, 12 oz.”. For the purpose of this disclosure, code types include 1D, 2D, PDF417, QR, RSS stacked, RSS composite, Micro PDF417 and Data Matrix.

Additional capabilities are activated based on user preference, for example:
Synchronizing with a store's pricing in order to also give the price, e.g. “Acme green peas, 12 oz., one dollar and twenty-two cents”.
Announcing a price with/without the store's rewards card, e.g. an Acme Frequent Shopper Card.
Calculating the cost per unit, e.g., “Acme green peas, 12 oz, one dollar and twenty cents, 10 cents per oz.”.
Giving Nutrition Facts (Serving Size, Servings per Container, Amount Per Serving [Calories, Calories from Fat, Total Fat, Saturated Fat, Trans Fat, Cholesterol, Sodium, Total Carbohydrate, Dietary Fiber, Sugars, Protein, Vitamin A, Calcium]}
Giving the Ingredients
Giving historical information for an item (packaged date, inspection date, shipped date, received date, pricing history, etc.)
Having the language be selectable, e.g. English, Spanish, French.

In various exemplary embodiments, the technology described herein provides a portable scanner device with integral audio output for audibly identifying a multiplicity of scanned items for a user. The portable scanner device comprises a hand-held housing, a sensor disposed within the housing (the sensor configured to detect and sense a scanned item), an audio output to aurally present audio data to the user of the portable scanner device, a processor to identify the scanned item and to generate an audio response through the audio output, a memory configured to store a plurality of data items for the processor, and a power source disposed within the housing. A speaker, an earphone, a headset and/or a wireless ear piece are used to present the audio data to the user of the portable scanner device.

In some embodiments the sensor is a radio-frequency identification (RFID) tag reader.

In some embodiments the sensor is a universal-product-code (UPC) scanner.

In some embodiments the sensor contains both a UPC scanner and a RFID tag reader.

In some embodiments a charger base unit to recharge the power source is included.

In some embodiments a synchronization port for utilization between the processor of the portable scanner device and an external device such as a cellular telephone, personal digital assistant (PDA), a portable scanner device base unit, or the like is included.

In some embodiments a synchronization port for utilization between the processor of the portable scanner device and a product and/or location identifier database located at a public venue or retail establishment, such as an airport, hospital, grocery, pharmacy, or the like, in order to synchronize the portable scanner device with the product and/or location identifier database, is included.

In some embodiments a memory port is included. This memory port is configured to receive a memory card, a memory stick or flash drive that is preloaded with data. One example of preloaded data is where a grocery store provides a flash drive with that day's current items, pricing and location for users to insert in their portable scanners prior to entering the store. Another example of preloaded data is where a tourist attraction provides a memory stick with the each portion of the attraction contained therein.

In some embodiments a microphone is included. One example of the use of the microphone is where a user is in a grocery store and speaks into the microphone “beer” and the portable device provide an audio response, “aisle 5”, based on the information provided from the memory device in the memory port.

In some embodiments a plurality of control/option buttons to adjust volume, scanning options, and/or location options, is included. A button or switch for language selection can also be included, as well as a view screen for displaying menus, instructions, information related to the scanning process, the control buttons, the language options, and the like.

In some embodiments the processor to identify the scanned item and to generate an audio response through the audio output is further configured to provide audibly a plurality of product and location identifier information.

The technology described herein also includes an UPC/RFID scanner with integrated audio output, comprising:
a hand-held housing;
a sensor disposed within the housing with the sensor configured to detect and sense a scanned item having a UPC code and/or an RFID tag;
at least one of an audio output to aurally present audio data to the user of the portable scanner device;
a processor to identify the scanned item and to generate an audio response through the audio output;
a memory configured to store a plurality of data items for the processor; and
a power source disposed within the housing.

In some embodiments the UPC/RFID scanner with integrated audio output further comprises a charger base unit to recharge the power source.

In some embodiments the UPC/RFID scanner with integrated audio output further comprises a synchronization port for utilization between the processor of the portable scanner device and an external device such as a cellular telephone, personal digital assistant (PDA), a portable scanner device base unit, or the like.

In some embodiments the UPC/RFID scanner with integrated audio output further comprises a synchronization port for utilization between the processor of the portable scanner device and a public venue or retail establishment, such as an airport, hospital, grocery, pharmacy, or the like, in order to synchronize the portable scanner device with a product and/or location identifier database.

In some embodiments the UPC/RFID scanner with integrated audio output further comprises a language selection switch configured to allow a user of the UPC/RFID scanner to receive the aurally presented audio data through the audio output in one of a plurality of preprogrammed and selectable languages, including, but not limited to, English, Spanish, French.

Other comparable uses are also contemplated herein, as will be obvious to those of ordinary skill in the art.

There has thus been outlined, rather broadly, the more important features of the technology in order that the detailed description thereof that follows may be better understood, and in order that the present contribution to the art may be better appreciated.

There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like system components and/or method steps, respectively, and in which:

FIG. 1 is a perspective view of a portable scanner device with integral audio output and a corresponding charging unit, according to an embodiment of the technology, illustrating, in particular, the scanner device above the charging unit.

FIG. 2 is a rear perspective view of the portable scanner device of FIG. 1, illustrating, in particular, the portable scanner device inserted into the charging unit.

FIG. 3 is a front perspective view of the portable scanner device of FIG. 1, illustrating, in particular, the portable scanner device inserted into the charging unit.

FIG. 4 is a rear plan view of a portable scanner device of FIG. 1.

FIG. 5 is a right side plan view of the portable scanner device of FIG. 1.

FIG. 6 is a bottom plan view of the portable scanner device of FIG. 1.

FIG. 7 is a top plan view of the portable scanner device of FIG. 1, illustrating, in particular, speaker holes, microphone holes and control buttons.

FIG. 8 is a front plan view of the portable scanner device of FIG. 1, illustrating, in particular, control buttons, USB port, Ethernet port, memory port, scanner, laser, and charging contacts.

FIG. 9 illustrates the portable scanner device of FIG. 1 being used to scan a bar-coded item.

FIG. 10 illustrates a head set for the portable scanner device of FIG. 1.

FIG. 11 illustrates a corded ear piece for the portable scanner device of FIG. 1.

FIG. 12 illustrates a wireless ear piece for the portable scanner device of FIG. 1.

FIG. 13 illustrates a charger for the portable scanner device of FIG. 1.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a portable scanning device with integral audio output for identifying coded objects. Other comparable uses are also contemplated herein, as will be obvious to those of ordinary skill in the art.

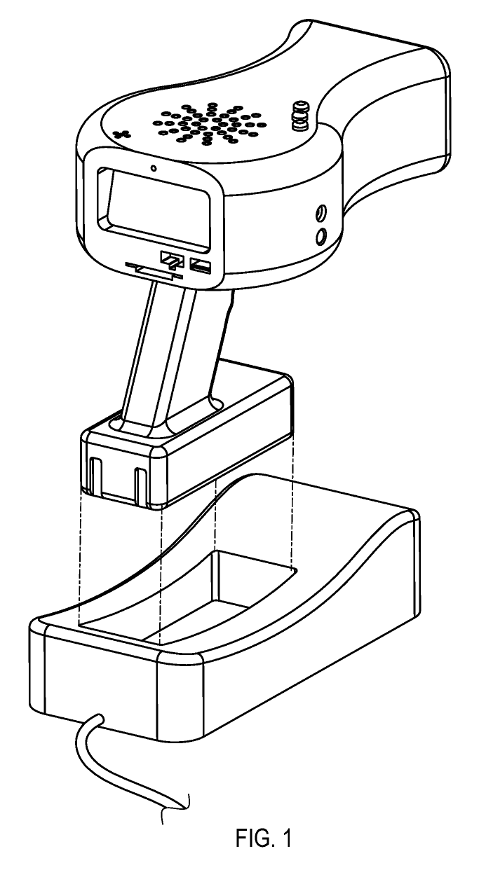

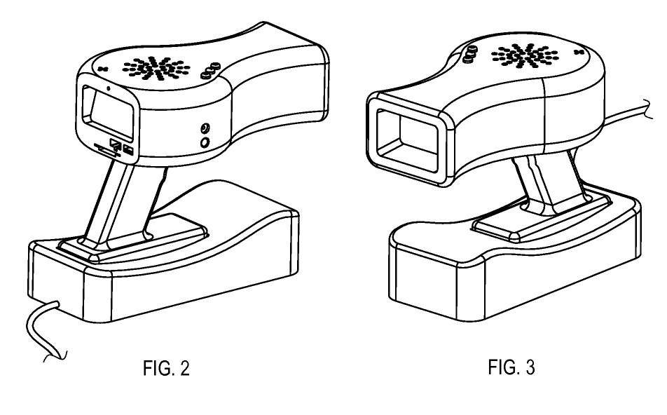

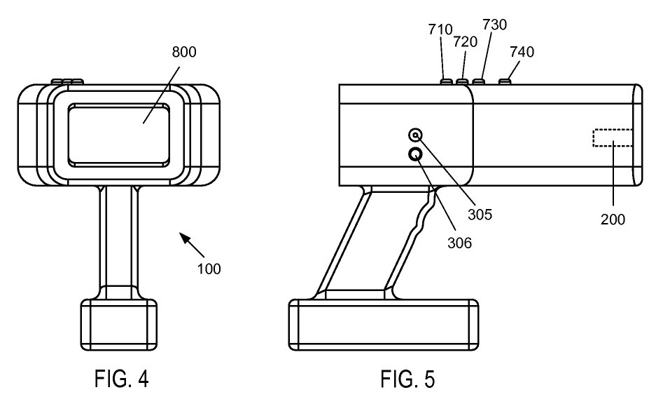

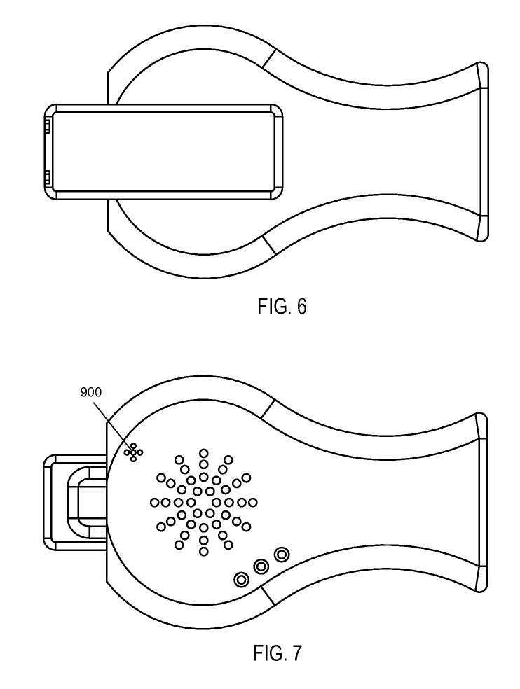

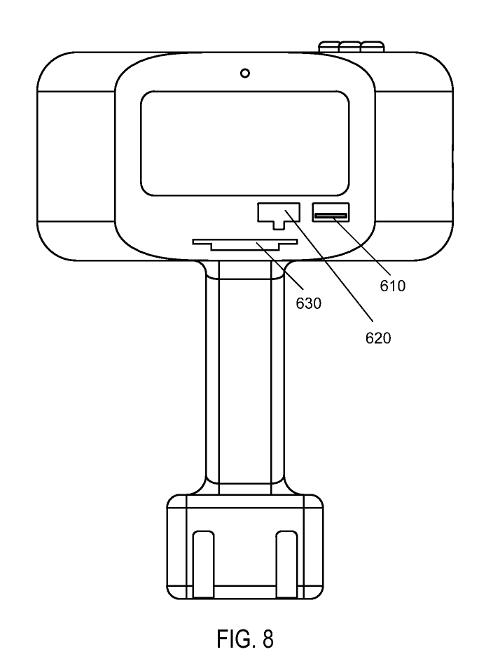

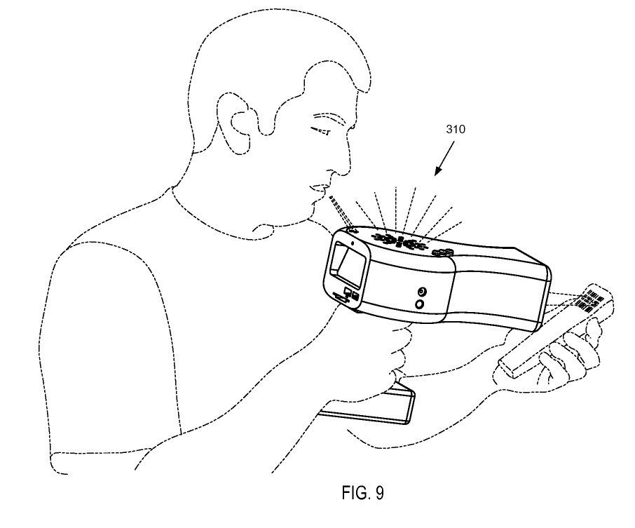

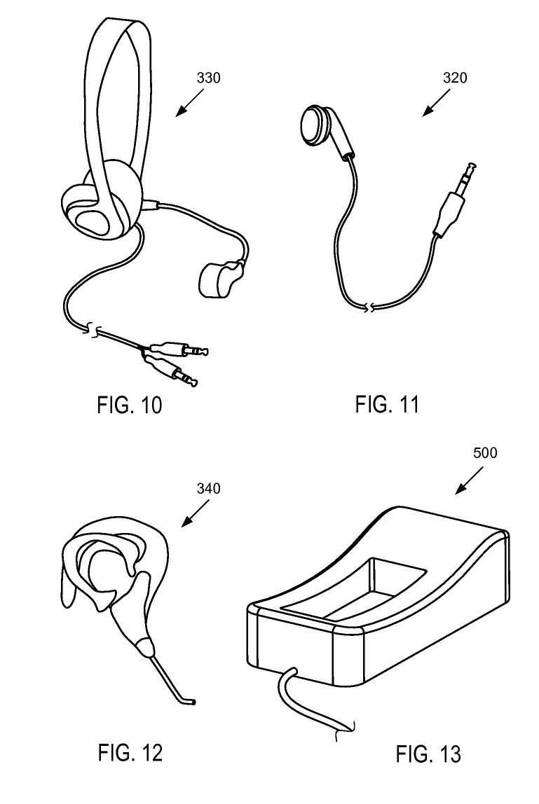

Referring now to FIGS. 1-13 a portable scanner device 10 is comprised of a hand-held housing 100, a sensor 200 disposed within the housing 100 and configured to detect and sense a scanned item, an audio output to aurally present audio data to the user of the portable scanner device 10, a processor (not shown) to identify the scanned item and to generate an audio response through the audio output, a memory (not shown) configured to store a plurality of data items for the processor, and a power source 400 disposed within the housing.

In some embodiments the portable scanner device 10 sensor 200 is a radio-frequency identification (RFID) tag reader. In other embodiments the sensor 200 is a universal product code (UPC) scanner. In some embodiments the sensor 200 is contains both an RFID tag reader and a UPC scanner.

The audio output that aurally presents audio data to the user of the portable scanner device 10 is a speaker 310, and can also include an ear phone 320, a headset 330 and/or a wireless ear piece 340. The earphone, headset and wireless ear piece communicate with the audio output, e.g. the earphone 320 connects to an earphone jack 305 disposed in the housing 100, the headset 330 connects to a headphone jack 306 in the housing and the wireless ear piece 340 wirelessly communicates with the audio output.

The portable scanner device 10 is further comprised of a charger base unit 500 to recharge the power source 400.

In some embodiments the portable scanner device 10 is further comprised of a synchronization port 610 for utilization between the processor of the portable scanner device 10 and an external device such as a cellular telephone, personal digital assistant (PDA), a portable scanner device base unit, or the like.

In some embodiments the portable scanner device 10 is further comprised of a synchronization port for utilization between the processor of the portable scanner device and a product and/or location identifier database located at a public venue or retail establishment, such as an airport, hospital, grocery, pharmacy, or the like, in order to synchronize the portable scanner device with the product and/or location identifier database. This synchronization port can be an Ethernet port 620, an integrated 802.11b/g wireless LAN component (not shown), or the like.

In some embodiments the portable scanner device 10 is further comprised of a plurality of control/option buttons, including, but not limited to, a volume button 710, a scanning option button 720, and a location option button 730.

In some embodiments the portable scanner device 10 is further comprised of a language selection switch (or button), 740, for user selection of a language to be used for audio output. These languages include, but are not limited to, English, Spanish and French. The portable scanner device is further comprised of a view screen 800 for display of information related to the display process, control buttons and/or language selection switch.

In some embodiments the processor is further configured to provide audibly a plurality of product and location identifier information, e.g. ingredient detail, price per unit, sodium level, sugar level, an ingredient to which the user is allergic.

In some embodiments the portable scanner device is further comprised of a memory port disposed on the scanner and configured to receive a memory card, memory stick, or flash drive preloaded with data pertaining to a plurality of items potentially scanned.

In some embodiments the portable scanner further comprises a microphone disposed on the scanner and configured to receive audible inputs from the user; and the audio output to aurally present audio data to the user of the portable scanner device is further configured to respond to the user audible input.

In some embodiments the sensor is further configured to scan a plurality of differing code types including 1D, 2D, PDF417, QR, RSS stacked, RSS composite, Micro PDF417, and Data matrix.

The technology described herein includes a method for scanning a multiplicity of items and audibly identifying the items for a user. This method comprises:
utilizing a portable scanner device comprising:
   a hand-held housing;
   a sensor, disposed within the housing, the sensor configured to detect and sense a scanned item;
   an audio output to aurally present audio data to the user of the portable scanner device;
   a processor to identify the scanned item and to generate an audio response through the audio output;
   a memory configured to store a plurality of data items for the processor; and
   a power source disposed within the housing;
scanning an item with the portable scanner device; and
receiving, aurally from the audio output of the portable scanner device, product and/or location information pertaining to the scanned item.

In some embodiments of this method the sensor is a RFID tag reader, and the method further comprises:
scanning an area for a radio-frequency identification (RFID) tag; and
receiving, aurally from the audio output of the portable scanner device, product and/or location information pertaining to the scanned item as identified by review of the RFID tag by the processor.

In other embodiments of the method the sensor is a UPC scanner, and the method further comprises:
scanning an item for a UPC; and
receiving, aurally from the audio output of the portable scanner device, product and/or location information pertaining to the scanned item as identified by review of the UPC code by the processor.

In some embodiments of the method the portable scanner device further comprises a synchronization port for utilization between the processor of the portable scanner device and an external data source, and the method further comprises:
synchronizing the portable scanner device with an external data source.

In some embodiments of the method the portable scanner device further comprises a synchronization port for utilization between the processor of the portable scanner device and an external device, and the method further comprises:
synchronizing the portable scanner device with an external device, such as a cellular telephone, personal digital assistant (PDA), a portable scanner device base unit, or the like.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A portable scanner device with integral audio output for audibly identifying a multiplicity of scanned items for a user, the device comprising:
a hand-held housing;
a sensor, disposed within the housing, the sensor configured to detect and sense a scanned item;
an audio output to aurally present audio data to the user of the portable scanner device;
a processor to identify the scanned item and to generate an audio response through the audio output;
a memory configured to store a plurality of data items for the processor; and
a power source disposed within the housing.

2. The portable scanner device with integral audio output for audibly identifying a multiplicity of scanned items for a user of claim 1, wherein the sensor is a radio-frequency identification (RFID) tag reader.

3. The portable scanner device with integral audio output for audibly identifying a multiplicity of scanned items for a user of claim 1, wherein the sensor is a universal product code (UPC) scanner.

4. The portable scanner device with integral audio output for audibly identifying a multiplicity of scanned items for a user of claim 1, wherein the audio output to aurally present audio data to the user of the portable scanner device further comprises a speaker.

5. The portable scanner device with integral audio output for audibly identifying a multiplicity of scanned items for a user of claim 1, wherein the audio output to aurally present audio data to the user of the portable scanner device further comprises an ear phone, headset, or wireless ear piece.

6. The portable scanner device with integral audio output for audibly identifying a multiplicity of scanned items for a user of claim 1, further comprising:
a charger base unit to recharge the power source.

7. The portable scanner device with integral audio output for audibly identifying a multiplicity of scanned items for a user of claim 1, further comprising:
a synchronization port for utilization between the processor of the portable scanner device and an external device such as a cellular telephone, personal digital assistant (PDA), a portable scanner device base unit, or the like.

8. The portable scanner device with integral audio output for audibly identifying a multiplicity of scanned items for a user of claim 1, further comprising:
a synchronization port for utilization between the processor of the portable scanner device and a product and/or location identifier database located at a public venue or retail establishment, such as an airport, hospital, grocery, pharmacy, or the like, in order to synchronize the portable scanner device with the product and/or location identifier database.

9. The portable scanner device with integral audio output for audibly identifying a multiplicity of scanned items for a user of claim 1, wherein the processor to identify the scanned item and to generate an audio response through the audio output is further configured to provide audibly a plurality of product and location identifier information.

10. The portable scanner device with integral audio output for audibly identifying a multiplicity of scanned items for a user of claim 1, further comprising:
a memory port disposed on the scanner and configured to receive a memory card, memory stick, or flash drive preloaded with data pertaining to a plurality of items potentially scanned.

11. The portable scanner device with integral audio output for audibly identifying a multiplicity of scanned items for a user of claim 1, further comprising:
a microphone disposed on the scanner and configured to receive audible inputs from the user; and
wherein the audio output to aurally present audio data to the user of the portable scanner device is further configured to respond to the user audible input.

12. The portable scanner device with integral audio output for audibly identifying a multiplicity of scanned items for a user of claim 1, wherein the sensor is further configured to scan a plurality of differing code types including 1D, 2D, PDF417, QR, RSS stacked, RSS composite, Micro PDF417, and Data matrix.

13. A method for scanning a multiplicity of items and audibly identifying the items for a user, the method comprising:
utilizing a portable scanner device comprising:
a hand-held housing;
a sensor, disposed within the housing, the sensor configured to detect and sense a scanned item;
an audio output to aurally present audio data to the user of the portable scanner device;
a processor to identify the scanned item and to generate an audio response through the audio output;
a memory configured to store a plurality of data items for the processor; and
a power source disposed within the housing;
scanning an item with the portable scanner device; and
receiving, aurally from the audio output of the portable scanner device, product and/or location information pertaining to the scanned item.

14. The method for scanning a multiplicity of items and audibly identifying the items for a user of claim 13, wherein the sensor is a radio-frequency identification (RFID) tag reader, the method further comprising:
scanning an area for a radio-frequency identification (RFID) tag; and
receiving, aurally from the audio output of the portable scanner device, product and/or location information pertaining to the scanned item as identified by review of the RFID tag by the processor.

15. The method for scanning a multiplicity of items and audibly identifying the items for a user of claim 13, wherein the sensor is a universal product code (UPC) scanner, the method further comprising:
scanning an item for a universal product code (UPC); and
receiving, aurally from the audio output of the portable scanner device, product and/or location information pertaining to the scanned item as identified by review of the UPC code by the processor.

16. The method for scanning a multiplicity of items and audibly identifying the items for a user of claim 13, wherein the portable scanner device further comprises a synchronization port for utilization between the processor of the portable scanner device and an external data source, the method further comprising:
synchronizing the portable scanner device with an external data source.

17. The method for scanning a multiplicity of items and audibly identifying the items for a user of claim 13 wherein the portable scanner device further comprises a synchronization port for utilization between the processor of the portable scanner device and an external device, the method further comprising:
synchronizing the portable scanner device with an external device, such as a cellular telephone, personal digital assistant (PDA), a portable scanner device base unit, or the like.

18. The method for scanning a multiplicity of items and audibly identifying the items for a user of claim 13, wherein the portable scanner device utilized further comprises a memory port disposed on the scanner and configured to receive a memory card, memory stick, or flash drive preloaded with data pertaining to a plurality of items potentially scanned; and further comprising:
recording in memory all items scanned regardless of whether the items scanned were ultimately purchased by the user.

19. A UPC/RFID scanner with integrated audio output, the UPC RFID scanner comprising:
a hand-held housing;
a sensor, disposed within the housing, the sensor configured to detect and sense a scanned item having a UPC code and/or an RFID tag;
an audio output to aurally present audio data to the user of the portable scanner device;
a processor to identify the scanned item and to generate an audio response through the audio output;
a memory configured to store a plurality of data items for the processor;
a power source disposed within the housing; and
a memory port disposed on the scanner and configured to receive an external memory card, memory stick, or flash drive preloaded with data pertaining to a plurality of items potentially scanned.

20. The UPC/RFID scanner with integrated audio output of claim 19, further comprising:
a charger base unit to recharge the power source.

21. The UPC/RFID scanner with integrated audio output of claim 19, further comprising:
a synchronization port for utilization between the processor of the portable scanner device and an external device such as a cellular telephone, personal digital assistant (PDA), a portable scanner device base unit, or the like.

22. The UPC/RFID scanner with integrated audio output of claim 19, further comprising:
a synchronization port for utilization between the processor of the portable scanner device and a public venue or retail establishment, such as an airport, hospital, grocery, pharmacy, or the like, in order to synchronize the portable scanner device with a product and/or location identifier database.

23. The UPC/RFID scanner with integrated audio output of claim 19, further comprising:
a language selectability switch configured to allow a user of the UPC/RFID scanner to receive the aurally presented audio data through the audio output in one of a plurality of preprogrammed and selectable languages.

24. The UPC/RFID scanner with integrated audio output of claim 19, further comprising:
a microphone disposed on the scanner and configured to receive audible inputs from the user; and
wherein the audio output to aurally present audio data to the user of the portable scanner device is further configured to respond to the user audible input.

25. The UPC/RFID scanner with integrated audio output of claim 19, wherein the sensor is further configured to scan a plurality of differing code types including 1D, 2D, PDF417, QR, RSS stacked, RSS composite, Micro PDF417, and Data matrix.
